(19) United States
(12) Patent Application Publication
(10) Pub. No.: US 2020/0153777 A1
(43) Pub. Date: May 14, 2020

(54) DEEP LEARNING-BASED SOCIAL MASHUP LOGIC IMPLEMENTATION SYSTEM AND METHOD FOR REDUCING ADVERSE EFFECTS OF SOCIAL NETWORKING SERVICE

(71) Applicant: CHA University Industry-Academic Cooperation Foundation, Pocheon-si (KR)

(72) Inventor: TaiKyeong Jeong, Seoul (KR)

(73) Assignee: CHA University Industry-Academic Cooperation Foundation, Pocheon-si (KR)

(21) Appl. No.: 16/217,053

(22) Filed: Dec. 12, 2018

(30) Foreign Application Priority Data
Nov. 13, 2018 (KR) 10-2018-0139204

(51) Int. Cl. H04L 12/58; G06N 3/08; G06N 3/04; H04L 29/08

(52) U.S. Cl. CPC H04L 51/32; H04L 51/12; G06N 3/08; G06Q 50/01; H04L 67/22; H04L 67/306; G06N 3/0454

(57) ABSTRACT

A deep learning-based social mashup logic implementation system, includes a user interface server configured to store data about a user's personal information, login information, activity information, and the like of web- and mobile-based interfaces, an external link server configured to store data about activities, a situation recognition server configured to sense mental and environmental changes of the user and store data related to the mental and environmental changes of the user, an analysis server configured to generate and store a relationship index obtained by numerically calculating a relationship between the user and the other user with an artificial neural network, and a management server configured to adjust a level of the other user's access to the user's posts and a level of exposing content uploaded by the user.

### CROSS-REFERENCE TO RELATED APPLICATION

This application claims priority to and the benefit of Korean Patent Application No. 10-2018-0139204, filed on Nov. 13, 2018, the disclosure of which is incorporated herein by reference in its entirety.

### BACKGROUND

### 1. Field of the Invention

The present invention relates to a deep learning-based social mashup logic implementation system and method for reducing adverse effects of a social networking service (SNS) and more particularly, to preemptive blocking and selective exposure for providing stability, connection, and appropriateness among users among techniques for reducing adverse effects of an SNS on the basis of deep learning.

### 2. Discussion of Related Art

With the development of Internet technology, many people are recently using SNSs. An SNS enables a user to construct an acquaintance network online and is also termed a personal connection management service and a community-type website.

The key of such an SNS is to build specific relationships between participants through a certain procedure, expand the range of the relationships, and consequently relay wide interaction between participants in a close manner. Representative SNSs are Facebook, Twitter, Instagram, MySpace, and the like.

In the case of Facebook, an edge link algorithm determines high-exposure posts on the basis of three elements, familiarity, weights, and time. As for familiarity, weights are given to content to which comments, “like,” and a sharing activity are applied by users. Decreasing weights are given in order of pictures, videos, text, and links, and the frequency of exposure increases in the case of a new post.

Such an SNS provides many users with advantages of a useful information source and expansion of human relations. However, SNSs expose users' personal information, content, etc. to many and unspecified people and thus have societal problems and adverse effects as well.

### SUMMARY OF THE INVENTION

The present invention is directed to providing a deep learning-based social mashup logic implementation system for reducing adverse effects of a social networking service (SNS), the system being capable of minimizing adverse effects of an SNS.

The present invention is also directed to providing a deep learning-based social mashup logic implementation method for reducing adverse effects of an SNS, the method being capable of minimizing adverse effects of an SNS.

According to an aspect of the present invention, there is provided a deep learning-based social mashup logic implementation system for reducing adverse effects of an SNS, the system including: a user interface server configured to store data about a user's personal information, login information, activity information, and the like of web- and mobile-based interfaces; an external link server configured to store data about activities done within a mutual relationship between the user and another user related to the user in a social medium, a school community, a local community, and the like; a situation recognition server configured to sense mental and environmental changes of the user based on the information stored in the user interface server and the external link server and store data related to the mental and environmental changes of the user; an analysis server configured to generate and store a relationship index obtained by numerically calculating a relationship between the user and the other user with an artificial neural network based on basic values stored in the user interface server, the external link server, and the situation recognition server and additional values which are added or changed by the user's activities and the like and stored in the user interface server, the external link server, and the situation recognition server; and a management server configured to adjust a level of the other user's access to the user's posts and a level of exposing content uploaded by the user according to the relationship index calculated by the analysis server.

The analysis server may analyze the relationship index using: a first level analysis operation of analyzing the relationship index using data stored in the user interface server, the external link server, and the situation recognition server as the basic values; a second level analysis operation of applying the additional values including information on subjects related to comments on the user's activities and posts to an analysis result of the first level analysis operation and analyzing a preference using a convolutional neural network (CNN); a third level analysis operation of re-analyzing the preference using a recurrent neural network (RNN) in consideration of a change made by an analysis result of the second level analysis operation; an operation of storing an analysis result of the third level analysis operation as a basic value; and an operation of repeatedly performing the first to third level analysis operations using data to which the analysis result of the third level analysis operation is applied. The relationship index may be classified into sections of the relationship index displayed to be 0 when the relationship is completely negative and displayed to be 100 when the relationship is completely positive, and the relationship index sections may include: a first section in which the relationship index is greater than or equal to 0 and smaller than 10; a second section in which the relationship index is greater than or equal to 10 and smaller than 25; a third section in which the relationship index is greater than or equal to 25 and smaller than 45; a fourth section in which the relationship index is greater than or equal to 45 and smaller than 65; a fifth section in which the relationship index is greater than or equal to 65 and smaller than 80; a sixth section in which the relationship index is greater than or equal to 80 and smaller than 90; and a seventh section in which the relationship index is greater than or equal to 90 and smaller than or equal to 100.

When the relationship index corresponds to the second to sixth sections, a threshold value of each section may serve as a threshold, and the level of the other user's access to the user's posts and the level of exposing the content uploaded by the user may be changed at a threshold value of each section. When the relationship index corresponds to the first section, that is, when the relationship index is smaller than 10, the other user's access to the user's posts may be immediately and completely blocked. When the relationship index corresponds to the seventh section, that is, when the relationship index is greater than or equal to 90, the user's posts may be immediately and entirely exposed.

The deep learning-based social mashup logic implementation system may further include an encryption section configured to generate a converted relationship index by converting the relationship index and store the converted relationship index. The relationship index may be calculated from every relationship between the user and another user.

The converted relationship index may include a coded index encoded to distinguish the relationship between the user and the other user, and an encrypted index obtained by encrypting the coded index.

The relationship index may be calculated in consideration of initial attraction indicating a degree of positive or negative reaction to the user's initial post, reactive attraction indicating a degree of positive or negative reaction to the user's post after comments are added to the post, surrounding element attraction indicating a degree of positive or negative reaction to surrounding elements related to a subject of the post, a tangible access level indicating variations in numbers of comments, conversations, and logins of the other user for the post, and an intangible access level indicating a type of the subject of the post.

The initial attraction may be calculated in consideration of a first element related to the user's age, a second element related to the user's residential area, a third element related to the user's sex, a fourth element related to the user's job, and a fifth element related to the user's time preference denoting whether the user frequently does activities in daytime or at night, and the initial attraction may be defined by an equation below:

$$C = \frac{{FC}_{n}}{{F}_{n}}$$

where C is the initial attraction, FCₙ is a number of posts having the same subject as the user's post among posts which satisfy the same conditions as the first to fifth elements, and Fₙ is a total number of posts which satisfy the same conditions as the first to fifth elements.

The surrounding element attraction may be calculated by applying additional values to the initial attraction through the second and third level analysis operations.

The reactive attraction may be defined by an equation below:

$$R = \frac{\sum ( \begin{matrix}The number of other {users}^{′} negative \\ comments on the {user}^{′} s post\end{matrix} \times \begin{matrix}The negative \\ level of a word\end{matrix} )}{\text{Total number of comments}} \times \begin{matrix}The level of the \\ {user}^{′} s rebuttal\end{matrix}$$

where R is the reactive attraction.

The tangible access level may be determined in consideration of a first type indicating amounts of comments and conversation about the subject of the post, a second type indicating proceeding speeds of comments and conversation about the subject of the post, a third type indicating a ratio of an increase in speed at which comments are added to an increase in an amount of comments since comments are added to the post, a fourth type indicating a total number of logins to the post, a fifth type indicating a number of repeated logins to the post, a sixth type indicating a ratio of the number of repeated logins to the total number of logins, and a seventh type indicating a ratio of a number of times that other posts are viewed to a number of times that the post is accessed and viewed. The tangible access level may be determined by an equation below:

D_{A}=ω₁×i₁+ω₂×i₂+ω₃×i₃+ω₄×i₄+ω₅×i₅+ω₆×i₆+ω₇×i₇

where D_{A} is the tangible access level, ω₁ to ω₇ are weights of the first to seventh types, and i₁ to i₇ are values of the first to seventh types.

When the post has no comments, the intangible access level may be calculated through the second level analysis operation and the third level analysis operation by applying a subject classified according to a purpose of the post to the initial attraction, and when the post has comments, the intangible access level may be calculated through the second level analysis operation and the third level analysis operation by applying a detailed type of a subject classified according to an overall purpose of the post including the comments to the reactive attraction.

The relationship index may be determined to be a value obtained by combining the initial attraction, the reactive attraction, the surrounding element attraction, and the tangible access level, and the relationship index may be defined by an equation below:

RC=ω_{c}×C+ωᵣ×R+ωₑ×E+ω_{d}×D_{A}

where RC is the relationship index, ω_{c} is a weight of the initial attraction, ωᵣ is a weight of the reactive attraction, ωₑ is a weight of the surrounding element attraction, ω_{d} is a weight of the tangible access level, C is the initial attraction, R is the reactive attraction, E is the surrounding element attraction, and D_{A} is the tangible access level.

According to another aspect of the present invention, there is provided a deep learning-based social mashup logic implementation method for reducing adverse effects of an SNS, the method including: storing, by a user interface server, data about a user's personal information, login information, activity information, and the like of web- and mobile-based interfaces; storing, by an external link server, data about activities done within a mutual relationship between the user and another user related to the user in a social medium, a school community, a local community, and the like; sensing, by a situation recognition server, mental and environmental changes of the user based on the information stored in the user interface server and the external link server and storing data related to the mental and environmental changes of the user; generating and storing, by an analysis server, a relationship index obtained by numerically calculating a relationship between the user and the other user with an artificial neural network based on basic values stored in the user interface server, the external link server, and the situation recognition server and additional values which are added or changed by the user's activities and the like and stored in the user interface server, the external link server, and the situation recognition server; and adjusting, by a management server, a level of the other user's access to the user's posts and a level of exposing content uploaded by the user according to the relationship index calculated by the analysis server.

The generating and storing of the relationship index obtained by numerically calculating the relationship with an artificial neural network may include: a first level analysis operation of analyzing the relationship index using data stored in the user interface server, the external link server, and the situation recognition server as the basic values; a second level analysis operation of applying the additional values including information on subjects related to comments on the user's activities and posts to an analysis result of the first level analysis operation and analyzing a preference using a CNN; a third level analysis operation of re-analyzing the preference using a RNN in consideration of a change made by an analysis result of the second level analysis operation; an operation of storing an analysis result of the third level analysis operation as a basic value; and an operation of repeatedly performing the first to third level analysis operations using data to which the analysis result of the third level analysis operation is applied.

The relationship index may be classified into sections of the relationship index displayed to be 0 when the relationship is completely negative and displayed to be 100 when the relationship is completely positive, and the relationship index sections may include a first section in which the relationship index is greater than or equal to 0 and smaller than 10, a second section in which the relationship index is greater than or equal to 10 and smaller than 25, a third section in which the relationship index is greater than or equal to 25 and smaller than 45, a fourth section in which the relationship index is greater than or equal to 45 and smaller than 65, a fifth section in which the relationship index is greater than or equal to 65 and smaller than 80, a sixth section in which the relationship index is greater than or equal to 80 and smaller than 90, and a seventh section in which the relationship index is greater than or equal to 90 and smaller than or equal to 100.

When the relationship index corresponds to the second to sixth sections, a threshold value of each section may serve as a threshold, and the level of the other user's access to the user's posts and the level of exposing the content uploaded by the user may be changed at a threshold value of each section. When the relationship index corresponds to the first section, that is, when the relationship index is smaller than 10, the other user's access to the user's posts may be immediately and completely blocked. When the relationship index corresponds to the seventh section, that is, when the relationship index is greater than or equal to 90, the user's posts may be immediately and entirely exposed.

The deep learning-based mashup logic implementation method may further include generating, by an encryption section, a converted relationship index obtained by converting the relationship index and storing the converted relationship index. The relationship index may be calculated from every relationship between the user and another user.

The generating of the converted relationship index may include: generating, by the encryption section, a coded index encoded to distinguish the relationship between the user and the other user; and generating, by the encryption section, an encrypted index obtained by encrypting the coded index.

The relationship index may be calculated in consideration of initial attraction indicating a degree of positive or negative reaction to the user's initial post, reactive attraction indicating a degree of positive or negative reaction to the user's post after comments are added to the post, surrounding element attraction indicating a degree of positive or negative reaction to surrounding elements related to a subject of the post, a tangible access level indicating variations in numbers of comments, conversations, and logins of the other user for the post, and an intangible access level indicating a type of the subject of the post.

The initial attraction may be calculated in consideration of a first element related to the user's age, a second element related to the user's residential area, a third element related to the user's sex, a fourth element related to the user's job, and a fifth element related to the user's time preference denoting whether the user frequently does activities in daytime or at night, and the initial attraction may be defined by an equation below:

$$C = \frac{{FC}_{n}}{{F}_{n}}$$

where C is the initial attraction, FCₙ is a number of posts having the same subject as the user's post among posts which satisfy the same conditions as the first to fifth elements, and Fₙ is a total number of posts which satisfy the same conditions as the first to fifth elements.

The surrounding element attraction may be calculated by applying additional values to the initial attraction through the second and third level analysis operations.

The reactive attraction may be defined by an equation below:

$$R = \frac{\sum ( \begin{matrix}The number of other {users}^{′} negative \\ comments on the {user}^{′} s post\end{matrix} \times \begin{matrix}The negative \\ level of a word\end{matrix} )}{\text{Total number of comments}} \times \begin{matrix}The level of the \\ {user}^{′} s rebuttal\end{matrix}$$

where R is the reactive attraction.

The tangible access level may be determined in consideration of a first type indicating amounts of comments and conversation about the subject of the post, a second type indicating proceeding speeds of comments and conversation about the subject of the post, a third type indicating a ratio of an increase in speed at which comments are added to an increase in an amount of comments since comments are added to the post, a fourth type indicating a total number of logins to the post, a fifth type indicating a number of repeated logins to the post, a sixth type indicating a ratio of the number of repeated logins to the total number of logins, and a seventh type indicating a ratio of a number of times that other posts are viewed to a number of times that the post is accessed and viewed. The tangible access level may be determined by an equation below:

D_{A}=ω₁×i₁+ω₂×i₂+ω₃×i₃+ω₄×i₄+ω₅×i₅+ω₆×i₆+ω₇×i₇

where D_{A} is the tangible access level, ω₁ to ω₇ are weights of the first to seventh types, and i₁ to i₇ are values of the first to seventh types.

When the post has no comments, the intangible access level may be calculated through the second level analysis operation and the third level analysis operation by applying a subject classified according to a purpose of the post to the initial attraction, and when the post has comments, the intangible access level may be calculated through the second level analysis operation and the third level analysis operation by applying a detailed type of a subject classified according to an overall purpose of the post including the comments to the reactive attraction.

The relationship index may be determined to be a value obtained by combining the initial attraction, the reactive attraction, the surrounding element attraction, and the tangible access level, and the relationship index may be defined by an equation below:

RC=ω_{c}×C+ωᵣ×R+ωₑ×E+ω_{d}×D_{A}

where RC is the relationship index, ω_{c} is a weight of the initial attraction, ωᵣ is a weight of the reactive attraction, ωₑ is a weight of the surrounding element attraction, ω_{d} is a weight of the tangible access level, C is the initial attraction, R is the reactive attraction, E is the surrounding element attraction, and D_{A} is the tangible access level.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram showing a deep learning-based mashup logic implementation system for reducing adverse effects of a social networking service (SNS) according to an exemplary embodiment of the present invention;

FIG. 2 is a flowchart illustrating a deep learning-based mashup logic implementation method for reducing adverse effects of an SNS according to an exemplary embodiment of the present invention;

FIG. 3 is a flowchart illustrating a relationship index analysis operation in the deep learning-based mashup logic implementation method for reducing adverse effects of an SNS according to an exemplary embodiment of the present invention;

FIG. 4 is a block diagram showing relationship index sections of a relationship index in the deep learning-based mashup logic implementation method for reducing adverse effects of an SNS according to an exemplary embodiment of the present invention;

FIG. 5 illustrates preemptive blocking and selective exposure of the deep learning-based mashup logic implementation method for reducing adverse effects of an SNS according to an exemplary embodiment of the present invention;

FIG. 6 illustrates selective exposure of the deep learning-based mashup logic implementation method for reducing adverse effects of an SNS according to an exemplary embodiment of the present invention;

FIG. 7 is a flowchart illustrating an access and exposure adjustment operation in the deep learning-based mashup logic implementation method for reducing adverse effects of an SNS according to an exemplary embodiment of the present invention;

FIG. 8 shows a coded index and an encrypted index in the deep learning-based mashup logic implementation method for reducing adverse effects of an SNS according to an exemplary embodiment of the present invention;

FIG. 9 shows a display section of the deep learning-based mashup logic implementation system for reducing adverse effects of an SNS according to an exemplary embodiment of the present invention; and

FIG. 10 shows the display section of the deep learning-based mashup logic implementation system for reducing adverse effects of an SNS according to an exemplary embodiment of the present invention.

### DETAILED DESCRIPTION OF EXEMPLARY EMBODIMENTS

While the present invention is susceptible to various modifications and alternative forms, specific embodiments will be shown in the drawings and described in detail. It should be understood, however, that the description is not intended to limit the preset invention to the particular forms disclosed herein, but the intention is to cover all modifications, equivalents, and replacements falling within the spirit and scope of the invention. Throughout the description of the drawings, like numbers refer to like elements. The terms “first,” “second,” and the like are used to describe various elements, but the elements are not limited by the terms.

The terms are only used to distinguish one element from another element. Terminology used herein is for the purpose of describing exemplary embodiments of the present invention only and is not intended to be limiting. The singular forms include the plural forms as well unless the context clearly indicates otherwise.

It should be understood that the terms “comprises,” “comprising,” “includes,” and “including” specify the presence of stated features, numerals, steps, operations, elements, parts, or combinations thereof, but do not preclude the presence or addition of one or more other features, numerals, steps, operations, elements, parts, or combinations thereof.

Unless otherwise defined, all terms including technical and scientific terms used herein have the same meaning as commonly understood by those of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

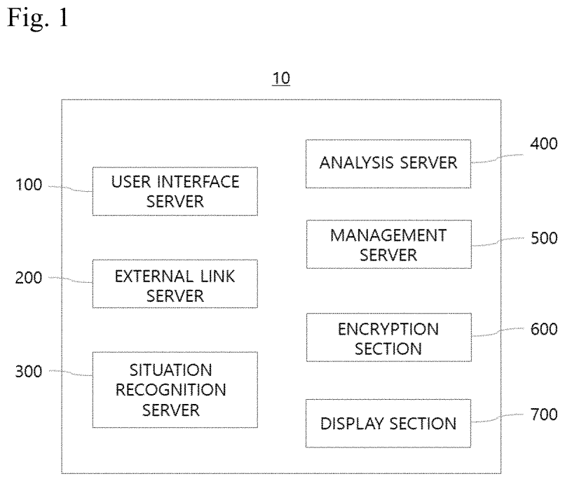

FIG. 1 is a block diagram showing a deep learning-based social mashup logic implementation system for reducing adverse effects of a social networking service (SNS) according to an exemplary embodiment of the present invention.

Referring to FIG. 1, a deep learning-based social mashup logic implementation system 10 for reducing adverse effects of an SNS according to an exemplary embodiment of the present invention includes a user interface server 100, an external link server 200, a situation recognition server 300, an analysis server 400, a management server 500, an encryption section 600, and a display section 700.

The user interface server 100 stores data about a user's personal information, login information, activity information, etc. of web- and mobile-based interfaces. The user interface server 100 may collect and store data about activity information such as websites that the user frequently accesses and concerns of the user in websites.

The external link server 200 stores data about activities done within a mutual relationship between the user and another user related to the user in a social medium, a school community, a local community, or the like. The external link server 200 may be connected to, for example, Facebook, Instagram, Naver blogs, or Kakaotalk, and may collect and store data about activities done within a mutual relationship between users and other users.

The situation recognition server 300 senses mental and environmental changes of the user on the basis of the information stored in the user interface server 100 and the external link server 200 and stores data related to the mental and environmental changes of the user. The situation recognition server 300 may collect and store environmental information, such as a temperature, a humidity, the amount of rainfall, a wind direction, and information on a residential area, recognition information, such as the user's visual cognitive response, spatial cognitive response, linguistic cognitive response, and story response, and activity information, such as an electrocardiogram, brain waves, and a body temperature collected from a wearable device and the like. Since the situation recognition server 300 stores data about the user's emotional or behavior change corresponding to a specific situation, it is possible to use the data in estimating the user's preference and the like for a similar situation.

The analysis server 400 generates and stores a relationship index which indicates a relationship between the user and the other user numerically calculated using an artificial neural network on the basis of basic values stored in the user interface server 100, the external link server 200, and the situation recognition server 300 and additional values which are added or changed by the user's activities and the like and stored in the user interface server 100, the external link server 200, and the situation recognition server 300.

The analysis server 400 may analyze a preference using a first level analysis operation of analyzing a relationship index using data stored in the user interface server 100, the external link server 200, and the situation recognition server 300 as basic values, a second level analysis operation of applying additional values including information on subjects related to comments on the user's activities and posts to an analysis result of the first level analysis operation and analyzing a preference using a convolutional neural network (CNN), a third level analysis operation of re-analyzing the preference using a recurrent neural network (RNN) in consideration of a change made by an analysis result of the second level analysis operation, an operation of storing an analysis result of the third level analysis operation as a basic value, and an operation of repeatedly performing the first to third level analysis operations using data to which the analysis result of the third level analysis operation is applied.

Therefore, unlike a general method of determining a next activity according to a pre-programmed event condition, additional values which are added or changed by activities of the user and then stored are applied to a preference analysis, and level-specific changes made by an artificial neural network are transferred to and have influence on next level analyses. Accordingly, since a mental change, a preference change, etc. caused by the user's activities may be immediately applied to a preference analysis, it is possible to provide a customized service for a relationship index between the user and another user.

The management server 500 provides a service of adjusting a level of another user's access to the user's posts and the degree of blocking or exposing content uploaded by the user using data about relationship indices analyzed by the analysis server 400.

Here, blocking and exposure may be defined as new concepts of preemptive blocking and selective exposure for improving an ideological leverage effect by adding core concepts. First, preemptive blocking refers to an operation of preemptively blocking another user who tries to access a user or the user's posts so that the user may use an SNS without anxiety. In this case, it is possible to provide the service such that the blocked user may not recognize that he or she has been blocked.

The ideological leverage effect of preemptive blocking and selective exposure denotes assurances and effects of an ideology indicating that blocking and exposure may lead to knowledge in social media and temporal and spatial benefits in communities on the basis of an economic ideology, that is, capitalism, like the economic profits of capital. In other words, the ideological leverage effect indicates that the leverage effect in economics is maximized with empathy in social media so that preemptive blocking and selective permission may be ideally performed and the most effective benefit, that is, maximization of the value of social media, may be obtained.

Next, selective exposure is exposure felt by a user that posts uploaded by the user are seen by people to whom he or she wants to show the posts. Selective exposure refers to exposure not only to people who are connected in specific relationships but also to people having tendencies or tastes similar to those of a user. For example, posts are open not only to users who are connected in a relationship, such as friends of Facebook. Rather, a user's posts are open to people to whom the user wants to show the posts while the people are modified according to relationship indices in consideration of various elements, such as tendency, job, age, and residential area, which are similar to those of the user among people around the user.

The encryption section 600 may generate a converted relationship index by converting the relationship index. The converted relationship index may include a coded index and an encrypted index.

The encryption section 600 generates the coded index by encoding the relationship index and generates the encrypted index by encrypting the coded index. The relationship index is calculated from every relationship between a user and another user and denotes a relationship between a user and another user. Therefore, since a relationship index includes sensitive information, it is necessary not to expose the relationship index to users. The encryption section 600 encrypts relationship indices and stores and manages the encrypted relationship indices. Therefore, users are not able to check information indicating a relationship between a user and another user. In this embodiment of the present invention, a method of calculating a relationship index and encrypting the relationship index is described as an example. However, the present invention is not limited to the method, and the encryption section 600 may protect security of relationship indices by generating encryption indices or encrypted non-identifiers.

The display section 700 may display a service in which the management server 500 adjusts the level of the other user's access to the user's posts and the degree of blocking or exposing content uploaded by the user.

For example, the display section 700 may show a current situation of an SNS in which the user is protected and content is exposed in “My Mode” which may be checked by the user and show a current situation of the SNS in which preemptive blocking and selective exposure proceed according to relationship indices of users in “Administrator Mode.”

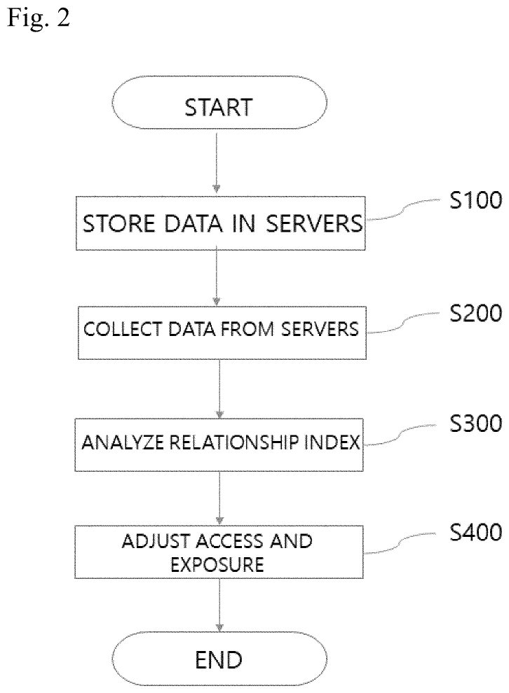

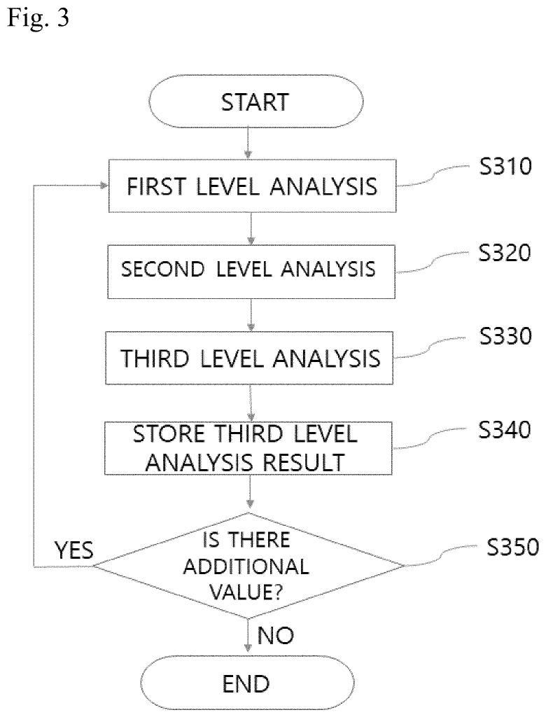

FIG. 2 is a flowchart illustrating a deep learning-based social mashup logic implementation method for reducing adverse effects of an SNS according to an exemplary embodiment of the present invention. FIG. 3 is a flowchart illustrating a relationship index analysis operation in the deep learning-based social mashup logic implementation method for reducing adverse effects of an SNS according to an exemplary embodiment of the present invention.

Referring to FIGS. 2 and 3, the deep learning-based social mashup logic implementation method for reducing adverse effects of an SNS according to an exemplary embodiment of the present invention includes an operation of storing data in each server (S100), an operation of collecting data from each server (S200), an operation of analyzing a relationship index using the collected data (S300), and an operation of providing a service of adjusting the level of another user's access to a user's posts and the level of exposing content uploaded by the user using data about the analyzed relationship index (S400).

The operation of storing data in each server (S100) may include an operation of storing data about the user's personal information, login information, activity information, etc. of web- and mobile-based interfaces in a user interface server, an operation of storing, in an external link server, data about activities done within a mutual relationship between the user and another user related to the user in a social medium, a school community, a local community, or the like, and an operation of sensing the user's metal and environmental changes on the basis of the information stored in the user interface server and the external link server and storing data related to the user's mental and environmental changes in a situation recognition server.

When data is stored in each server, data required for a relationship index analysis may be collected in the operation of collecting data from each server (S200).

In the operation of analyzing a relationship index using the collected data (S300), an analysis server analyzes the user's preference for other users and the user's preference for a specific thing or situation using an artificial neural network on the basis of basic values stored in the user interface server, the external link server, and the situation recognition server and additional values which are added or changed by the user's activities and the like and then stored in the user interface server, the external link server, and the situation recognition server.

The operation of analyzing a relationship index using the collected data (S300) may include a first level analysis operation (S310), a second level analysis operation (S320), a third level analysis operation (S330), an operation of storing a third level analysis result (S340), an operation of determining whether there is an additional value (S350), and an operation of repeatedly performing the first to third level analysis operations using data to which the third level analysis result is applied.

In the first level analysis operation (S310), the relationship index is analyzed using data stored in the user interface server, the external link server, and the situation recognition server as basic values. In the first level analysis operation (S310), the user's relationship index is analyzed mainly using data related to the user's preference for other users and the user's preference for the specific thing or situation among data stored in each server.

In the first level analysis operation (S310), a preference is analyzed by arbitrating a subject's preference for an object and the object's preference for the subject. The preference analyzed by arbitrating the subject's preference for the object and the object's preference for the subject in the first level analysis operation (S310) may be defined by Equation 1 below.

L₁=A̅₁̅⊕̅B̅₁̅ [Equation 1]

Here, L₁ is the preference analyzed in the first level analysis operation, A₁ is the subject's preference for the object in the first level analysis operation, and B₁ is the object's preference for the subject in the first level analysis operation.

In the second level analysis operation (S320), additional values which are added or changed by the user's activities and then stored are applied to the analysis result of the first level analysis operation (S310), and the user's preference is analyzed using a CNN.

In the second level analysis operation (S320), the subject's preference for the object and the object's preference for the subject are arbitrated, and a preference is analyzed by applying the analysis result of the first level analysis operation (S310) to the arbitrated preference. The preference analyzed by arbitrating the subject's preference for the object and the object's preference for the subject in the second level analysis operation (S320) may be defined by Equation 2 below.

$${L}_{2} = ( \overline{\overline{{A}_{1} ⊕ {B}_{1}} ) ⊕ ( \overline{{A}_{2} ⊕ {B}_{2}}} ) \qquad [ Equation 2 ]$$

Here, L₂ is the preference analyzed in the second level analysis operation, A₁ is the subject's preference for the object in the first level analysis operation, B₁ is the object's preference for the subject in the first level analysis operation, A₂ is the subject's preference for the object in the second level analysis operation, and B₂ is the object's preference for the subject in the second level analysis operation.

In the third level analysis operation (S330), the preference is re-analyzed using a RNN in consideration of a change made by the second level analysis result. Therefore, the changes made by the additional values in the second level analysis operation may be transferred to the third level analysis operation.

In the third level analysis operation (S330), the subject's preference for the object and the object's preference for the subject are arbitrated, and a preference is analyzed by applying the analysis result of the second level analysis operation (S320) to the arbitrated preference. The preference analyzed by arbitrating the subject's preference for the object and the object's preference for the subject in the third level analysis operation (S330) may be defined by Equation 3 below.

$${L}_{3} = ( \overline{\overline{( \overline{{A}_{1} ⊕ {B}_{1}} ) ⊕ ( \overline{{A}_{2} ⊕ {B}_{2}} )} ) ⊕ ( \overline{{A}_{3} ⊕ {B}_{3}}} ) \qquad [ Equation 3 ]$$

Here, L₃ is the preference analyzed in the third level analysis operation, A₁ is the subject's preference for the object in the first level analysis operation, B₁ is the object's preference for the subject in the first level analysis operation, A₂ is the subject's preference for the object in the second level analysis operation, B₂ is the object's preference for the subject in the second level analysis operation, A₃ is the subject's preference for the object in the third level analysis operation, and B₃ is the object's preference for the subject in the third level analysis operation.

In other words, in each of the first to third level analysis operations, a preference is analyzed by arbitrating the subject's preference for the object and the object's preference for the subject. The analysis result of the first level analysis operation is applied to the second level analysis operation, and the analysis result of the second level analysis operation to which the analysis result of the first level analysis operation is applied is applied to the third level analysis operation.

Subsequently, in the operation of storing the analysis result of the third level analysis operation (S340), the analysis result of the third level analysis operation is stored as a basic value. Therefore, the analysis results of the first to third level analysis operations are stored as basic values, and the preference may be re-analyzed by applying additional values which are newly added or changed by the user's activities. Consequently, it is possible to immediately reflect the user's mental or preference changes made by the user' activities.

Subsequently, in the operation of determining whether there is an additional value (S350), it is determined whether there is a newly added value after the first to third level analysis operations are performed. When there is no additional value, the preference analysis is finished, and when there is an additional value, the first to third level analysis operations are repeated while the additional value is applied to the operations.

In the operation of analyzing the preference using the subject's preference for the object and the object's preference for the subject (S330), a result of the operation of performing first to third level analyses on the subject with respect to the object (S310) and a result of the operation of performing first to third level analyses on the object with respect to the subject (S320) are arbitrated. Therefore, in the operation (S330), it is possible to analyze the preference to which the subject's preference for the object and the object's preference for the subject are appropriately applied.

When a user is the subject and another user is the object, the basic values may include the subject's preference for the object, the object's preference for the subject obtained by reversing the relationship between the subject and the object, and a preference to which interactions between the subject and the object are applied. Also, the additional value may include the subject's preference for the object changed according to the subject's activities, the object's preference for the subject changed according to the object's activities, and a changed preference to which interactions changed according to activities of the subject and the object are applied. In other words, the basic values are information on users' past activities and the like stored in each server, and the additional value is information newly added or changed by users' activities.

Basically, the relationship between a subject and an object starts from a one-to-multiple relationship rather than a one-to-one relationship, and the object's preference for the subject is also analyzed by reversing the relationship between the subject and the object. Therefore, when nodes relating to the relationship between the subject and the object are repeatedly increased, the relationship between the subject and the object may be expanded to a multiple-to-multiple relationship.

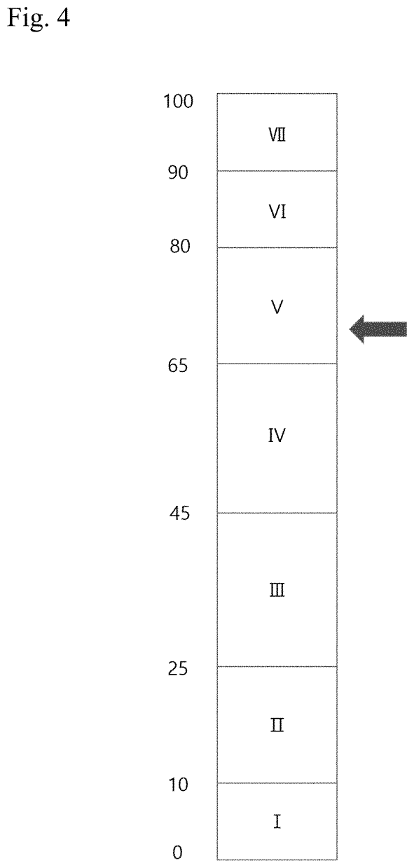

In the operation of providing a service of adjusting the level of another user's access to the user's posts and the level of exposing content uploaded by the user using data about the analyzed relationship index (S400), the level of another user's access to the user's posts and the degree of blocking or exposing content uploaded by the user may be adjusted according to the relationship index. A method of adjusting the level of another user's access to the user's posts and the degree of blocking or exposing content uploaded by the user will be described in detail with reference to FIG. 4.

FIG. 4 is a block diagram showing relationship index sections of a relationship index in the deep learning-based social mashup logic implementation method for reducing adverse effects of an SNS according to an exemplary embodiment of the present invention.

Referring to FIG. 4, values of a relationship index used in the deep learning-based social mashup logic implementation method for reducing adverse effects of an SNS according to an exemplary embodiment of the present invention may be divided into relationship index sections.

Within the relationship index sections, the relationship index may have a value of 0 when the relationship is completely negative and may have a value of 100 when the relationship is completely positive.

The relationship index sections may include a first section in which the relationship index is greater than or equal to 0 and smaller than 10, a second section in which the relationship index is greater than or equal to 10 and smaller than 25, a third section in which the relationship index is greater than or equal to 25 and smaller than 45, a fourth section in which the relationship index is greater than or equal to 45 and smaller than 65, a fifth section in which the relationship index is greater than or equal to 65 and smaller than 80, a sixth section in which the relationship index is greater than or equal to 80 and smaller than 90, and a seventh section in which the relationship index is greater than or equal to 90 and smaller than or equal to 100.

When the relationship index corresponds to the second to sixth sections, a threshold value of each section serves as a threshold, and the level of another user's access to a user's posts and the level of exposing content uploaded by the user are changed at a threshold value of each section. When the relationship index corresponds to the first section, that is, when the relationship index is smaller than 10, another user's access to the user's posts may be immediately and completely blocked. When the relationship index corresponds to the seventh section, that is, when the relationship index is greater than or equal to 90, the user's posts may be immediately and entirely exposed.

A current value of the relationship index may be indicated by an arrow as shown in FIG. 4. For example, FIG. 4 shows that the relationship index currently corresponds to the fifth section.

The relationship index may be calculated in consideration of initial attraction indicating the degree of positive or negative reaction to a user's initial post, reactive attraction indicating the degree of positive or negative reaction to the user's post after comments are added to the post, surrounding element attraction indicating the degree of positive or negative reaction to surrounding elements related to a subject of the post, a tangible access level indicating variations in the numbers of comments, conversations, and logins of the other user for the post, and an intangible access level indicating a type of the subject of the post.

The initial attraction denotes a basis for making a decision on the initial original post (a video, an image, or text) to which no comments are added. The initial attraction has a value according to whether several elements are matched with a current time and area.

The initial attraction may be calculated through the first level analysis operation in consideration of a first element related to the user's age, a second element related to the user's residential area, a third element related to the user's sex, a fourth element related to the user's job, and a fifth element related to the user's time preference denoting whether the user frequently does activities in daytime or at night.

The initial attraction may he defined by Equation 4 below.

$$C = \frac{{FC}_{n}}{{F}_{n}} \qquad [ Equation 4 ]$$

Here, C is an initial attraction, FCₙ is the number of posts having the same subject as the user's post among posts which satisfy the same conditions as the first to fifth elements, and Fₙ is the total number of posts which satisfy the same conditions as the first to fifth elements.

The surrounding element attraction denotes the degree of positive or negative reaction to surrounding elements related to the subject of the post. The surrounding element attraction may be determined by considering both situations before and after comments are added to the post. Surrounding elements may include information such as a climate, a credit rating, health status, an electrocardiogram, brain waves, and a body temperature. For example, climate information may be collected using public data of the National Weather Service, credit rating information may be collected using data about credit card use, and health status information may be collected using medical information data. Since the user is not simply affected by a single surrounding element, two or more pieces of data rather than one piece of data may be considered in combination as surrounding elements.

The surrounding element attraction may be calculated by applying additional values to the initial attraction through the second and third level analysis operations.

The reactive attraction denotes the degree of positive or negative reaction to the user's post after comments are added to the post. In other words, the reactive attraction may denote the degree of positive or negative reaction after responses are made to the subject of the post, that is, after the post is uploaded. The reactive attraction may suggest a basis for making a decision, which follows the initial attraction, on the post (mainly text among videos, images, and text) after comments are added to the post.

The reactive attraction may be defined by Equation 5 below.

$$[ Equation 5 ]$$

$$R = \frac{\sum ( \begin{matrix}The number of other {users}^{′} negative \\ comments on the {user}^{′} s post\end{matrix} \times \begin{matrix}The negative \\ level of a word\end{matrix} )}{\text{Total number of comments}} \times \begin{matrix}The level of the \\ {user}^{′} s rebuttal\end{matrix}$$

Here, R is the reactive attraction.

In Equation 5 above, negative comments, the negative level of a word and the level of the user's rebuttal may be quantified using a sentiment dictionary or a negative level analysis application programming interface (API) provided by Google, IBM Watson, and the like. However, the present invention is not limited thereto, and negative comments, the negative level of a word, the level of the user's rebuttal, etc. may be quantified using various dictionaries, software, etc. capable of numerically indicating the negative level and the like.

The tangible access level indicates variations in the numbers of comments, conversations, and logins of other users for the post. The tangible access level indicates a relationship between the subject and the object and is, for example, a criterion for measuring the degree of influence of a subject A on objects B, C, D, etc. as access with tangible elements.

The tangible access level may include a first type indicating the amounts of comments and conversation about the subject of the post, a second type indicating the proceeding speeds of comments and conversation about the subject of the post, a third type indicating a ratio of an increase in the speed at which comments are added to an increase in the amount of comments since comments are added to the post, a fourth type indicating the total number of logins to the post, a fifth type indicating the number of repeated logins to the post, a sixth type indicating a ratio of the number of repeated logins to the total number of logins, and a seventh type indicating a ratio of the number of times that other posts are viewed to the number of times that the post is accessed and viewed.

The tangible access level may be defined by Equation 6 below.

D_{A}=ω₁×i₁+ω₂×i₂+ω₃×i₃+ω₄×i₄+ω₅×i₅+ω₆×i₆+ω₇×i₇ [Equation 6]

Here, D_{A} is the tangible access level, ω₁ to ω₇ are weights of the first to seventh types, and i₁ to i₇ are values of the first to seventh types.

The intangible access level indicates the degree of a characteristic according to a subject type of the post. To indicate an intangible relationship between the subject and the object on the basis of conversations, it is necessary to find all subjects, that is, basic types of conversations about posts.

When a characteristic of a subject handled by the subject and the object is indicated as the degree of access, the degree of access may be found through a characteristic of the post except for comments or a characteristic of the post including comments.

First, when the post has no comments, a basic type is found by classifying the post by purpose. For example, subjects of the post may be classified into: 1. the purpose of friendship between friends; 2. a business purpose; 3. a public purpose; 4. a political purpose; 5. the purpose of providing convenience; 6. the purpose of travel; 7. the purpose of research; 8: the purpose of small profits and quick returns; 9. the purpose of education; 10. the purpose of heath; 11. a commercial purpose; and the like.

On the other hand, when the post includes comments, the degree of access may be determined by finding detailed types. For example, 1. the purpose of friendship between friends may be classified into detailed types such as social contact, information exchange, test, pure friendship, money, etc., and 2. the business purpose may be classified into detailed types such as economy, debate, costs, etc. This embodiment of the present invention is not limited to the detailed types, and the degree of access may be determined by considering various detailed types.

When the post has no comments, the intangible access level may be calculated through the second level analysis operation and the third level analysis operation by applying a subject classified according to the purpose of the post to the initial attraction. On the other hand, when the post has comments, the intangible access level may be calculated through the second level analysis operation and the third level analysis operation by applying a detailed type of a subject classified according to the overall purpose of the post including the comments to the reactive attraction. In other words, the intangible access level may make it possible to calculate the initial attraction and the reactive attraction more precisely through the second level analysis operation and the third level analysis operation. The relationship index may be determined to be a value obtained by combining the initial attraction, the reactive attraction, the surrounding element attraction, and the tangible access level.

The relationship index may be defined by Equation 7 below.

RC=ω_{c}×C+ωᵣ×R+ωₑ×E+ω_{d}×D_{A} [Equation 7]

Here, RC is the relationship index, ω_{c} is a weight of the initial attraction, ωᵣ is a weight of the reactive attraction, ωₑ is a weight of the surrounding element attraction, ω_{d} is a weight of the tangible access level, C is the initial attraction, R is the reactive attraction, E is the surrounding element attraction, and D_{A} is the tangible access level.

The relationship index is determined by combining the initial attraction, the reactive attraction, the surrounding element attraction, and the tangible access level. At this time, all the elements may be taken into consideration, or elements unnecessary for a determination of the relationship index may be excluded.

For example, when it is unnecessary to consider the tangible access level, the weight of the tangible access level may be set to 0, and then the relationship index may be determined. In this case, the relationship index is determined by considering the initial attraction, the reactive attraction, and the surrounding element attraction. However, the present invention is not limited thereto, and the relationship index may be determined to be various combinations of the elements as necessary.

The relationship index may be classified as a first case in which the relationship index is determined by considering only the surrounding element attraction, a second case in which the relationship index is determined by considering the initial attraction and the reactive attraction, a third case in which the relationship index is determined by considering the initial attraction and the surrounding element attraction, a fourth case in which the relationship index is determined by considering the initial attraction, the reactive attraction, and the surrounding element attraction, a fifth case in which the relationship index is determined by considering the initial attraction, the reactive attraction, the surrounding element attraction, and the tangible access level, and the like.

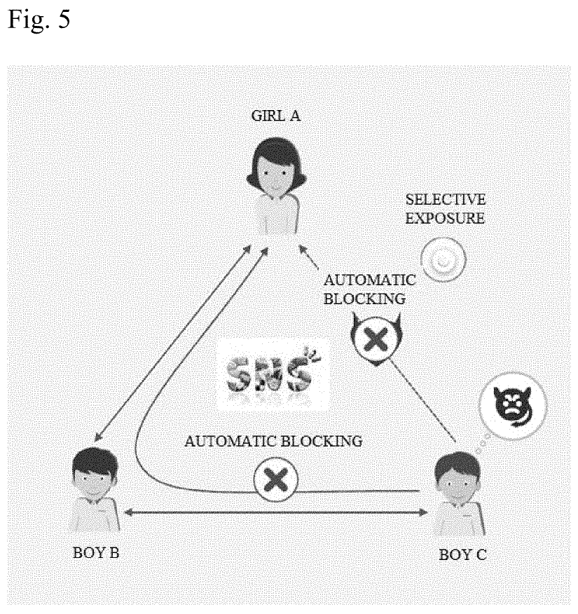

FIG. 5 illustrates preemptive blocking and selective exposure of the deep learning-based mashup logic implementation method for reducing adverse effects of an SNS according to an exemplary embodiment of the present invention.

Referring to FIG. 5, it is possible to preemptively block the relationship between a user and another user and selectively expose posts using the deep learning-based mashup logic implementation method for reducing adverse effects of an SNS according to an exemplary embodiment of the present invention.

When a girl A and a boy B are friends, a boy C is a friend of the boy B, and the girl A and the boy C are not friends, the boy C may be interested in the girl A through an SNS of the boy B.

In this case, the boy C may access the girl A normally but may also attempt to stalk the girl A by locating the girl A with her post, adding a weird comment to her post, and the like. Then, activities of the boy C may be determined to have low reactive attractions, and a surrounding element attraction and the tangible access level may also be lowered due to the activities of the boy C.

In this case, in the deep learning-based mashup logic implementation method for reducing adverse effects of an SNS according to an exemplary embodiment of the present invention, a relationship index of the boy C with the girl A may be calculated, and access of the boy C to the girl A may be preemptively blocked according to a section of the relationship index. Also, selective exposure is performed together with preemptive blocking.

Therefore, not only direct access of the boy C to the girl A but also indirect access of the boy C to the girl A via the boy B is blocked, and selective exposure disables the boy C from accessing posts of the girl A but enables the boy B to access posts of the girl A.

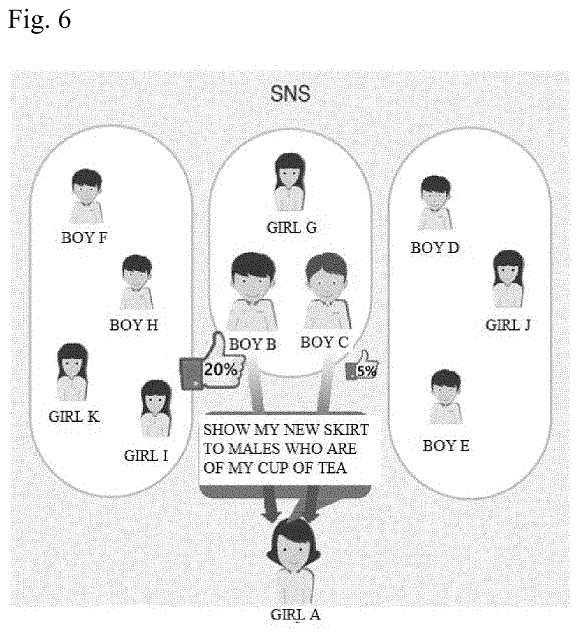

FIG. 6 illustrates selective exposure of the deep learning-based mashup logic implementation method for reducing adverse effects of an SNS according to an exemplary embodiment of the present invention.

Referring to FIG. 6, in the deep learning-based mashup logic implementation method for reducing adverse effects of an SNS according to an exemplary embodiment of the present invention, a user's posts may be selectively exposed.

Assuming that a girl A has purchased a new skirt and uploaded a picture of the skirt, the girl A may want to show her post to her friends of the opposite sex.

In this case, in the deep learning-based mashup logic implementation method for reducing adverse effects of an SNS according to an exemplary embodiment of the present invention, friends of the opposite sex appropriate for the girl A may be automatically recommended, and the post of the girl A may be selectively exposed to the recommended friends according to relationship indices.

In other words, relationship indices of users around the girl A are analyzed, and boys B and C who are users having high relationship indices are automatically recommended. Also, selective exposure is performed to the boy B whose relationship index is 20 and the boy C whose relationship index is 5 according to the relationship indices. Therefore, it is possible to show a post to only people that a user wants and give a safe feeling from stalking and the like so that anxiety may be dispelled.

When activities and mental behavior of the boy C are changed in the SNS, exposure and blocking of the girl A to the boy C may be automatically changed according to an artificial intelligence-based social media mashup algorithm. In other words, when activities and mental behavior of the boy C are changed, a relationship index between the girl A and the boy C is changed, and exposure and blocking of the girl A to the boy C may be automatically changed with the change in the relationship index by the artificial intelligence-based social media mashup algorithm.

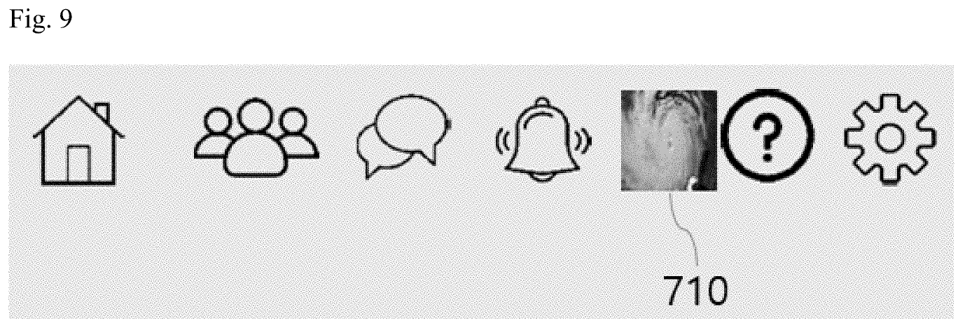

FIG. 8 shows a coded index and an encrypted index of the deep learning-based mashup logic implementation system for reducing adverse effects of an SNS according to an exemplary embodiment of the present invention.

Referring to FIGS. 1 and 8, the encryption section 600 of the deep learning-based mashup logic implementation system 10 for reducing adverse effects of an SNS according to an exemplary embodiment of the present invention may generate a converted relationship index by converting a relationship index. The converted relationship index may include a coded index 610 and an encrypted index 620.

The encryption section 600 generates the coded index 610 by encoding the relationship index and generates the encrypted index 620 by encrypting the coded index 610. The relationship index is calculated from every relationship between a user and another user and denotes a relationship between a user and another user.

The management server 500 receives only the encrypted index 620 and may adjust the degree of blocking or exposure with the encrypted index 620. Therefore, only an encrypted unique identification number is used, and thus a user's personal information such as a user identification (ID) is not exposed.

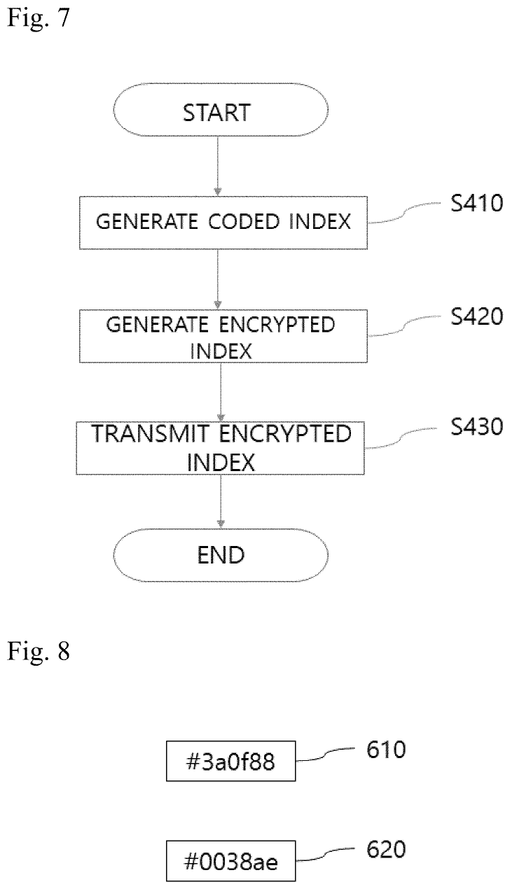

FIG. 7 is a flowchart illustrating the access and exposure adjustment operation in the deep learning-based mashup logic implementation method for reducing adverse effects of an SNS according to an exemplary embodiment of the present invention.

Referring to FIG. 7, in the deep learning-based mashup logic implementation method for reducing adverse effects of an SNS according to an exemplary embodiment of the present invention, the operation of adjusting access and exposure (S400) may include an operation of generating a coded index (S410), an operation of generating an encrypted index (S420), and an operation of transmitting the encrypted index (S430).

In the operation of generating a coded index (S410), a coded index is generated by encoding the relationship index. The coded index refers to an index which has not been encrypted and is generated by simple encoding.

In the operation of generating an encrypted index (S420), an encrypted index is generated by encrypting the coded index. The encrypted index refers to an index obtained by encrypting the coded index. In the operation of generating an encrypted index (S420), an encrypted index or an encrypted non-identifier may be generated.

In the operation of transmitting the encrypted index (S430), the encrypted index is transmitted to the management server 500. Subsequently, the management server 500 may adjust the degree of blocking or exposure with the encrypted index.

FIG. 9 shows the display section of the deep learning-based mashup logic implementation system for reducing adverse effects of an SNS according to an exemplary embodiment of the present invention.

Referring to FIG. 9, the display section 700 of the deep learning-based mashup logic implementation system for reducing adverse effects of an SNS according to an exemplary embodiment of the present invention may include various menus displayed in “My Mode.”

Among the various menus displayed in the display section 700, a specific relationship icon 710 may show a current situation in which a user is protected and content is exposed in an SNS. For example, the specific relationship icon 710 may be displayed in a hurricane shape, and the hurricane shape may be enlarged or reduced to intuitively show the degree of exposure or blocking of the user. When the hurricane shape is enlarged, it denotes that many exposure and blocking operations are being performed, and when the hurricane shape is reduced, it denotes that a few exposure and blocking operations are being performed.

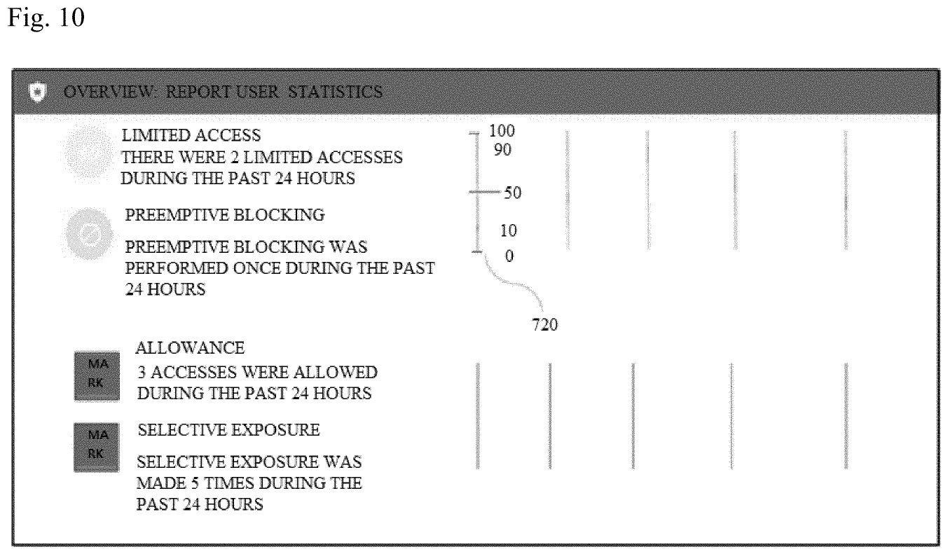

FIG. 10 shows the display section of the deep learning-based mashup logic implementation system for reducing adverse effects of an SNS according to an exemplary embodiment of the present invention.

Referring to FIG. 10, the display section 700 of the deep learning-based mashup logic implementation system for reducing adverse effects of an SNS according to an exemplary embodiment of the present invention may include various menus displayed in “Administrator Mode.”

“Administrator Mode” may include a relationship index display section 720 for displaying a relationship index between a user and another user in a chart. The relationship index display section 720 may show a current situation in which preemptive blocking and selective exposure are performed according to a relationship index between users in an SNS.

The relationship index display section 720 displays the relationship index shown in FIG. 4 in a chart, and the relationship index may be generated by quantifying the ideological leverage of blocking and exposure. Also, the relationship index display section 720 may display changes in relationships between the user and other users by displaying the relationship index in real time.

According to the present invention, the deep learning-based social mashup logic implementation system for reducing adverse effects of an SNS does not simply analyze a relationship index between a user and another user but rather analyzes the relationship index while immediately reflecting information generated from interaction with the other user and information added or changed by the user's activities. Therefore, it is possible to provide a customized service for the relationship between a user and another user rather than mechanical blocking or exposure.

Also, since the deep learning-based social mashup logic implementation system for reducing adverse effects of an SNS according to an exemplary embodiment of the present invention is able to provide a customized service for a user's situation, it is possible to prevent thoughtless exposure and block access of another user whom the user does not want. Consequently, adverse effects of an SNS may be reduced.

Although the present invention has been described above with reference to exemplary embodiments, those of ordinary skill in the art will appreciate that various modifications and alterations can be made without departing from the spirit or scope of the invention as defined by the following claims.

What is claimed is:

1. A deep learning-based mashup logic implementation system for reducing adverse effects of a social networking service (SNS), the system comprising:
a user interface server configured to store data about a user's personal information, login information, activity information, and the like of web- and mobile-based interfaces;
an external link server configured to store data about activities done within a mutual relationship between the user and another user related to the user in a social medium, a school community, a local community, and the like;
a situation recognition server configured to sense mental and environmental changes of the user based on the information stored in the user interface server and the external link server and store data related to the mental and environmental changes of the user;
an analysis server configured to generate and store a relationship index obtained by numerically calculating a relationship between the user and the other user with an artificial neural network based on basic values stored in the user interface server, the external link server, and the situation recognition server and additional values which are added or changed by the user's activities and the like and stored in the user interface server, the external link server, and the situation recognition server; and
a management server configured to adjust a level of the other user's access to the user's posts and a level of exposing content uploaded by the user according to the relationship index calculated by the analysis server.

2. The deep learning-based mashup logic implementation system of claim 1, wherein the analysis server analyzes the relationship index using:
a first level analysis operation of analyzing the relationship index using data stored in the user interface server, the external link server, and the situation recognition server as the basic values;
a second level analysis operation of applying the additional values including information on subjects related to comments on the user's activities and posts to an analysis result of the first level analysis operation and analyzing a preference using a convolutional neural network (CNN);
a third level analysis operation of re-analyzing the preference using a recurrent neural network (RNN) in consideration of a change made by an analysis result of the second level analysis operation;
an operation of storing an analysis result of the third level analysis operation as a basic value; and
an operation of repeatedly performing the first to third level analysis operations using data to which the analysis result of the third level analysis operation is applied.

3. The deep learning-based mashup logic implementation system of claim 1, wherein the relationship index is classified into sections of the relationship index displayed to be 0 when the relationship is completely negative and displayed to be 100 when the relationship is completely positive, and
the relationship index sections include:
a first section in which the relationship index is greater than or equal to 0 and smaller than 10;
a second section in which the relationship index is greater than or equal to 10 and smaller than 25;
a third section in which the relationship index is greater than or equal to 25 and smaller than 45;
a fourth section in which the relationship index is greater than or equal to 45 and smaller than 65;
a fifth section in which the relationship index is greater than or equal to 65 and smaller than 80;
a sixth section in which the relationship index is greater than or equal to 80 and smaller than 90; and
a seventh section in which the relationship index is greater than or equal to 90 and smaller than or equal to 100.

4. The deep learning-based mashup logic implementation system of claim 3, wherein when the relationship index corresponds to the second to sixth sections, a threshold value of each section serves as a threshold, and the level of the other user's access to the user's posts and the level of exposing the content uploaded by the user are changed at a threshold value of each section,
when the relationship index corresponds to the first section, that is, when the relationship index is smaller than 10, the other user's access to the user's posts is immediately and completely blocked, and
when the relationship index corresponds to the seventh section, that is, when the relationship index is greater than or equal to 90, the user's posts are immediately and entirely exposed.

5. The deep learning-based mashup logic implementation system of claim 1, further comprising an encryption section configured to generate a converted relationship index by converting the relationship index and store the converted relationship index,
wherein the relationship index is calculated from every relationship between the user and another user.

6. The deep learning-based mashup logic implementation system of claim 5, wherein the converted relationship index includes:
a coded index encoded to distinguish the relationship between the user and the other user; and
an encrypted index obtained by encrypting the coded index.

7. The deep learning-based mashup logic implementation system of claim 2, wherein the relationship index is calculated in consideration of initial attraction indicating a degree of positive or negative reaction to the user's initial post, reactive attraction indicating a degree of positive or negative reaction to the user's post after comments are added to the post, surrounding element attraction indicating a degree of positive or negative reaction to surrounding elements related to a subject of the post, a tangible access level indicating variations in numbers of comments, conversations, and logins of the other user for the post, and an intangible access level indicating a type of the subject of the post.

8. The deep learning-based mashup logic implementation system of claim 7, wherein the initial attraction is calculated in consideration of a first element related to the user's age, a second element related to the user's residential area, a third element related to the user's sex, a fourth element related to the user's job, and a fifth element related to the user's time preference denoting whether the user frequently does activities in daytime or at night, and
the initial attraction is defined by an equation below:
$$C = \frac{{FC}_{n}}{{F}_{n}}$$
where C is the initial attraction, FCₙ is a number of posts having the same subject as the user's post among posts which satisfy the same conditions as the first to fifth elements, and Fₙ is a total number of posts which satisfy the same conditions as the first to fifth elements.

9. The deep learning-based mashup logic implementation system of claim 8, wherein the surrounding element attraction is calculated by applying additional values to the initial attraction through the second and third level analysis operations.

10. The deep learning-based mashup logic implementation system of claim 7, wherein the reactive attraction is defined by an equation below:
$$R = \frac{\sum ( \begin{matrix}The number of other {users}^{′} negative \\ comments on the {user}^{′} s post\end{matrix} \times \begin{matrix}The negative \\ level of a word\end{matrix} )}{\text{Total number of comments}} \times \begin{matrix}The level of the \\ {user}^{′} s rebuttal\end{matrix}$$
where R is the reactive attraction.

11. The deep learning-based mashup logic implementation system of claim 7, wherein the tangible access level is determined in consideration of a first type indicating amounts of comments and conversation about the subject of the post, a second type indicating proceeding speeds of comments and conversation about the subject of the post, a third type indicating a ratio of an increase in speed at which comments are added to an increase in an amount of comments since comments are added to the post, a fourth type indicating a total number of logins to the post, a fifth type indicating a number of repeated logins to the post, a sixth type indicating a ratio of the number of repeated logins to the total number of logins, and a seventh type indicating a ratio of a number of times that other posts are viewed to a number of times that the post is accessed and viewed, and
the tangible access level is determined by an equation below:
D_{A}=ω₁×i₁+ω₂×i₂+ω₃×i₃+ω₄×i₄+ω₅×i₅+ω₆×i₆+ω₇×i₇
where D_{A} is the tangible access level, ω₁ to ω₇ are weights of the first to seventh types, and i₁ to i₇ are values of the first to seventh types.

12. The deep learning-based mashup logic implementation system of claim 7, wherein when the post has no comments, the intangible access level is calculated through the second level analysis operation and the third level analysis operation by applying a subject classified according to a purpose of the post to the initial attraction, and
when the post has comments, the intangible access level is calculated through the second level analysis operation and the third level analysis operation by applying a detailed type of a subject classified according to an overall purpose of the post including the comments to the reactive attraction.

13. The deep learning-based mashup logic implementation system of claim 7, wherein the relationship index is determined to be a value obtained by combining the initial attraction, the reactive attraction, the surrounding element attraction, and the tangible access level, and
the relationship index is defined by an equation below:
RC=ω_{c}×C+ωᵣ×R+ωₑ×E+ω_{d}×D_{A}
where RC is the relationship index, ω_{c} is a weight of the initial attraction, ωᵣ is a weight of the reactive attraction, ωₑ is a weight of the surrounding element attraction, ω_{d} is a weight of the tangible access level, C is the initial attraction, R is the reactive attraction, E is the surrounding element attraction, and D_{A} is the tangible access level.

14. A deep learning-based mashup logic implementation method for reducing adverse effects of a social networking service (SNS), the method comprising:
storing, by a user interface server, data about a user's personal information, login information, activity information, and the like of web- and mobile-based interfaces;
storing, by an external link server, data about activities done within a mutual relationship between the user and another user related to the user in a social medium, a school community, a local community, and the like;
sensing, by a situation recognition server, mental and environmental changes of the user based on the information stored in the user interface server and the external link server and storing data related to the mental and environmental changes of the user;
generating and storing, by an analysis server, a relationship index obtained by numerically calculating a relationship between the user and the other user with an artificial neural network based on basic values stored in the user interface server, the external link server, and the situation recognition server and additional values which are added or changed by the user's activities and the like and stored in the user interface server, the external link server, and the situation recognition server; and
adjusting, by a management server, a level of the other user's access to the user's posts and a level of exposing content uploaded by the user according to the relationship index calculated by the analysis server.

15. The deep learning-based mashup logic implementation method of claim 14, wherein the generating and storing of the relationship index obtained by numerically calculating the relationship with the artificial neural network comprises:
a first level analysis operation of analyzing the relationship index using data stored in the user interface server, the external link server, and the situation recognition server as the basic values;
a second level analysis operation of applying the additional values including information on subjects related to comments on the user's activities and posts to an analysis result of the first level analysis operation and analyzing a preference using a convolutional neural network (CNN);
a third level analysis operation of re-analyzing the preference using a recurrent neural network (RNN) in consideration of a change made by an analysis result of the second level analysis operation;
an operation of storing an analysis result of the third level analysis operation as a basic value; and
an operation of repeatedly performing the first to third level analysis operations using data to which the analysis result of the third level analysis operation is applied.

16. The deep learning-based mashup logic implementation method of claim 14, wherein the relationship index is classified into sections of the relationship index displayed to be 0 when the relationship is completely negative and displayed to be 100 when the relationship is completely positive, and
the relationship index sections include:
a first section in which the relationship index is greater than or equal to 0 and smaller than 10;
a second section in which the relationship index is greater than or equal to 10 and smaller than 25;
a third section in which the relationship index is greater than or equal to 25 and smaller than 45;
a fourth section in which the relationship index is greater than or equal to 45 and smaller than 65;
a fifth section in which the relationship index is greater than or equal to 65 and smaller than 80;
a sixth section in which the relationship index is greater than or equal to 80 and smaller than 90; and
a seventh section in which the relationship index is greater than or equal to 90 and smaller than or equal to 100.

17. The deep learning-based mashup logic implementation method of claim 16, wherein when the relationship index corresponds to the second to sixth sections, a threshold value of each section serves as a threshold, and the level of the other user's access to the user's posts and the level of exposing the content uploaded by the user are changed at a threshold value of each section,
when the relationship index corresponds to the first section, that is, when the relationship index is smaller than 10, the other user's access to the user's posts is immediately and completely blocked, and
when the relationship index corresponds to the seventh section, that is, when the relationship index is greater than or equal to 90, the user's posts are immediately and entirely exposed.

18. The deep learning-based mashup logic implementation method of claim 14, further comprising generating, by an encryption section, a converted relationship index obtained by converting the relationship index and storing the converted relationship index,
wherein the relationship index is calculated from every relationship between the user and another user.

19. The deep learning-based mashup logic implementation method of claim 18, wherein the generating of the converted relationship index comprises:
generating, by the encryption section, a coded index encoded to distinguish the relationship between the user and the other user; and
generating, by the encryption section, an encrypted index obtained by encrypting the coded index.

20. The deep learning-based mashup logic implementation method of claim 15, wherein the relationship index is calculated in consideration of initial attraction indicating a degree of positive or negative reaction to the user's initial post, reactive attraction indicating a degree of positive or negative reaction to the user's post after comments are added to the post, surrounding element attraction indicating a degree of positive or negative reaction to surrounding elements related to a subject of the post, a tangible access level indicating variations in numbers of comments, conversations, and logins of the other user for the post, and an intangible access level indicating a type of the subject of the post.

21. The deep learning-based mashup logic implementation method of claim 20, wherein the initial attraction is calculated in consideration of a first element related to the user's age, a second element related to the user's residential area, a third element related to the user's sex, a fourth element related to the user's job, and a fifth element related to the user's time preference denoting whether the user frequently does activities in daytime or at night, and
the initial attraction is defined by an equation below:
$$C = \frac{{FC}_{n}}{{F}_{n}}$$
where C is the initial attraction, FCₙ is a number of posts having the same subject as the user's post among posts which satisfy the same conditions as the first to fifth elements, and Fₙ is a total number of posts which satisfy the same conditions as the first to fifth elements.

22. The deep learning-based mashup logic implementation method of claim 21, wherein the surrounding element attraction is calculated by applying additional values to the initial attraction through the second and third level analysis operations.

23. The deep learning-based mashup logic implementation method of claim 20, wherein the reactive attraction is defined by an equation below:
$$R = \frac{\sum ( \begin{matrix}The number of other {users}^{′} negative \\ comments on the {user}^{′} s post\end{matrix} \times \begin{matrix}The negative \\ level of a word\end{matrix} )}{\text{Total number of comments}} \times \begin{matrix}The level of the \\ {user}^{′} s rebuttal\end{matrix}$$
where R is the reactive attraction.

24. The deep learning-based mashup logic implementation method of claim 20, wherein the tangible access level is determined in consideration of a first type indicating amounts of comments and conversation about the subject of the post, a second type indicating proceeding speeds of comments and conversation about the subject of the post, a third type indicating a ratio of an increase in speed at which comments are added to an increase in an amount of comments since comments are added to the post, a fourth type indicating a total number of logins to the post, a fifth type indicating a number of repeated logins to the post, a sixth type indicating a ratio of the number of repeated logins to the total number of logins, and a seventh type indicating a ratio of a number of times that other posts are viewed to a number of times that the post is accessed and viewed, and
the tangible access level is determined by an equation below:
D_{A}=ω₁×i₁+ω₂×i₂+ω₃×i₃+ω₄×i₄+ω₅×i₅+ω₆×i₆+ω₇×i₇
where D_{A} is the tangible access level, ω₁ to ω₇ are weights of the first to seventh types, and i₁ to i₇ are values of the first to seventh types.

25. The deep learning-based mashup logic implementation method of claim 20, wherein when the post has no comments, the intangible access level is calculated through the second level analysis operation and the third level analysis operation by applying a subject classified according to a purpose of the post to the initial attraction, and
when the post has comments, the intangible access level is calculated through the second level analysis operation and the third level analysis operation by applying a detailed type of a subject classified according to an overall purpose of the post including the comments to the reactive attraction.

26. The deep learning-based mashup logic implementation method of claim 20, wherein the relationship index is determined to be a value obtained by combining the initial attraction, the reactive attraction, the surrounding element attraction, and the tangible access level, and
the relationship index is defined by an equation below:
RC=ω_{c}×C+ωᵣ×R+ωₑ×E+ω_{d}×D_{A}
where RC is the relationship index, ω_{c} is a weight of the initial attraction, ωᵣ is a weight of the reactive attraction, ω_{c} is a weight of the surrounding element attraction, ω_{d} is a weight of the tangible access level, C is the initial attraction, R is the reactive attraction, E is the surrounding element attraction, and D_{A} is the tangible access level.
